(19) United States
(12) Patent Application Publication
(10) Pub. No.: US 2007/0186353 A1
(43) Pub. Date: Aug. 16, 2007

(54) Fire resistant fabric formed from treated fibers

(76) Inventor: Xinggao Fang, Duncan, SC (US)

Correspondence Address: MILLIKEN & COMPANY, PO BOX 1926, SPARTANBURG, SC, 29303, US

(21) Appl. No.: 11/351,692

(22) Filed: Feb. 10, 2006

(51) Int. Cl. C11D 3/00; D06M 23/00; D06M 11/00

(52) U.S. Cl. 8/115.51; 8/116.1; 8/127.1

(57) ABSTRACT

The invention relates to a process for forming a fire resistant textile comprising treating unconsolidated fibers with an aqueous solution comprising a phosphoric or phosphonic acid salt and a weak base, drying the fiber at 140° C. to 200° C., and forming the treated fibers into a textile.

### Technical Field

The present invention generally relates to a process for treating fibers to be fire resistant with water durability. More particularly, the invention relates to a process for fire resistant treating fibers comprising treating a fiber with an aqueous solution comprising a phosphoric or phosphonic acid salt and a weak base and drying the fiber at 140 to 200° C. and further forming the treated fiber into a textile.

### BACKGROUND

Fabrics containing cellulosic fibers are routinely made fire resistant by use of phosphate fire retardants. Ammonium phosphate and ammonium polyphosphate are particularly useful fire retardants because of their high effectiveness and low cost. A major disadvantage of these types of treatments is their lack of durability to moisture exposure. Phosphorous based fire retardants are readily water soluble and is leached out of the fabric when exposed to water.

Much work has been directed to creating a fire resistant fabric that is water resistant (or durable). One particular development was treating fabric with a mixture containing ammonium phosphate and a weak base such as urea. Under extended high temperature exposure (150-200° C. for several minutes), phosphate agent is thought to be chemically bonded to the cellulosic fabric. Unfortunately, when this treatment is applied to fabrics, the harsh conditions cause detrimental effects, including considerable loss of fabric physical strength and the fabric becoming undesirably stiff. This can be seen, for example, in U.S. Pat. No. 2,526,462, where the inclusion of additional washing steps is used to improve the softness and flexibility of the fabric and the heating cycle is as short as possible to minimize the loss of strength of the fabric.

In another method, fabric is treated with a phosphate fire retardant together with hydrocarbons. This method is claimed to offer fabric with water leach resistant fire retardancy. This treatment does not need high temperature to fix phosphate fire retardant to the fabric;however, the added hydrocarbons contribute to flammability of the fabric.

Thus, there is still a need to make fire resistant fabric that is water resistant and retains other desirable physical properties.

### DETAILED DESCRIPTION OF THE INVENTION

The invention process provides fibers with fire resistance and water durability. The process consists of treating unconsolidated fibers with an aqueous solution of a phosphoric or phosphonic acid salt and a weak base and drying the fiber at 140° C. to 200° C. By unconsolidated fibers, what is meant is that the fibers have not been consolidated into a structure, such as a textile. This is a departure from the prior art method of treating the fabric under this process. When fabrics are treated with this process, the fabric becomes weak and stiff, both of which are very undesirable characteristics. When treating the fabrics, to remove the stiffness, fabric conditioners or additional washing steps are necessary and these additional steps are costly and complicated and may adversely affect the water durability and/or the fire resistance of the fabric. When fibers are subjected to the process of the invention, the fabrics produced there from have fire resistance and water durability and are both strong and soft to the hand.

Woven and knit fabrics are generally held together through cohesive interactions between the fibers of the fabric, between the yarns of the fabric, and between the fibers and yarns of the fabric. Nonwoven fabrics are largely held together by the cohesive interactions between the fibers in the nonwoven material. In some situations when a high loft nonwoven structure is desired, cohesive interactions between fibers are too weak to provide a fabric of sufficient integrity, thus a separate low melt fiber is typically added that usually melts during heating. The melted fiber serves as a glue to help hold fibers together as a fabric. When these fabrics are then treated with the phosphoric or phosphonic acid salts as described above, a significant amount of the cohesive interactions between the fibers are reduced or broken. This leads to fabrics with much lower strength, among other issues. On the other hand, when fibers are treated before being formed into a fabric, there is less of a concern about weakening the cohesive interactions. Once the fibers are treated, they are then formed into a fabric (with or without a separate low melt fiber), and these fibers are able to form cohesive interactions with the other fibers in the fabrics, thus creating a strong, fire resistant fabric.

Preferably, the molar ratio of the phosphoric acid salt or phosphonic acid salt and the weak base is between 0.1:1 and 2:1, more preferably 0.25:1 and 1:1. These ratios have been proven to provide high levels of fire resistance with water durability. The amount of phosphoric acid salts gives high level of fire resistance (typically 10-20% on weight of fiber). If the solution pH becomes is too low due to formation of excess phosphoric acid, the fibers will degrade, turn yellow, or brown, etc. As to the mechanism of how a base such as urea helps fix the phosphate to the fiber, it appears that the phosphorylation of cellulose goes through an amidophosphate intermediate. In addition, the base can physically swell the fiber so the phosphate can more easily move into the fiber.

Preferably, the phosphoric acid salt is ammonium hydrogenephosphate ammonium dihydrogenephosphate, or ammonium polyphosphate. These phosphoric acid salts have been found to be readily available and relatively inexpensive. It is believed that ammonium phosphate salts are effective fire resistant agents because at the high temperatures of a fire, these materials decompose to gaseous ammonia that will dilute free radicals in the flame, helping to reduce the flame. It is also believed that the other component of decomposition is phosphoric acid or popyphosphoric acid, which helps decompose cellulosic polymers to certain structures that form intermediates that are not readily burned, but form incompletely burned chars. In other embodiments, the fire retardants can be other phosphorus compounds, such as ammonium (poly)phosphonates or tetrakis(hydroxymethyl) phosphonium salt. Preferably, the treated fiber contains 5 to 25% by weight of the phosphoric or phosphonic acid salt. This range is important because too little phosphoric acid salt could not offer enough protection, while too much of it is costly and makes the fiber, and the fabric made from the fibers, feel rough and stiff.

Preferably, the weak base comprises urea or cyanoguanidine. Other weak bases can include guanidine, cyanoamide, or others. Urea helps swell the textile fibers and serves as a pH buffer. The weak base, together with the flame retardants, form a good buffer system so that the resultant pH of the chemical mixture is typically between 5 and 8. (The fibers treated will also typically have a similar pH range). The pH of the process mixture should be approximately neutral so that fibers treated have fire resistance and minimal degradation resulting in desired fiber properties. If the pH is too low or too high, the textile fibers will have excess degradation. In particular, a high pH will cause release of ammonia gas into the air, a process and safety issue.

It has been found that treatment of cellulosic fibers with (poly)phosphate salts and weak base can make phosphate salt attached to the cellulosic fibers when exposed to certain temperatures. Preferably, the fibers are dried at a temperature of between 140 and 200° C., more preferably 150 to 170° C. This range of drying temperatures is critical to achieving the fire resistant fibers with water durability. Below this range, the fibers will not have good flame retardance with water durability because the phosphorylation of cellulosic fibers is not effective enough under practical conditions and the swelling of fibers is also less effective. Above this temperature range, the fibers will degrade significantly, causing loss of physical strength, and turn yellow. The higher the drying temperature, the easier phosphate attaches to the fiber, so the shorter the drying time required; however, the high temperature will cause fiber degradation and evaporation/degradation of other agents. The chemical reaction of fixing the phosphate to the fiber at low temperatures is typically too slow to be practical for commercial applications.

Fabrics such as nonwoven fabric could be made with thus treated unconsolidated fibers via laydown with a card, airlay, or other technique and subsequent thermobonding or consolidation. Additional fibers such as low melting fibers could be blended in small amount to offer stronger physical properties in thermobonding. Low melt fibers can include synthetic fibers made from polyethylene, polypropylene, other polyolefins or copolymers of polyolefins, or blends thereof. Preferably, at least one polymer in the low melt fibers has a melt temperature of less than 185° C. Low melting polyester and polyvinylchloride fibers can also be used. These are generally biocomponent fibers with one component of lower melting point such as in the range of 110 to 170° C. Low melt fibers are typically used in the amount of 5-40% on weight of the total composition, preferably 10-30%.

The fabric may also be a woven, knit, non-woven material, tufted, or the like. Woven textiles can include, but are not limited to, satin, poplin, and crepe weave textiles. Knit textiles can include, but are not limited to, circular knit, warp knit, and warp knit with a microdenier face. The textile may be flat, or may exhibit a pile.

In one embodiment, the fabric is a non-woven of high loft. High loft nonwovens are low density fabrics characterized by a high ratio of thickness to weight per unit area, which means that high lofts contain considerable void volume.

Unconsolidated fibers that contain hydroxyl groups are preferred because that can react with phosphoric acid salts. The fibers may be, but are not limited to cellulosic, cotton, rayon, lyocell, and polyvinyl alcohol fibers.

In one embodiment, a cellulosic fiber is treated with an aqueous solution of ammonium polyphosphate and urea, the fibers are dried at a temperature between 150 and 170° C. and then the fibers are formed into a fabric. These conditions have been shown to produce fire resistant and water durable fabrics that have both strength and softness without the need for additional steps.

Other typical textile finishing agents may be added for other desired properties. For example, optical brighteners, blueing agents for adjusting color, hydrophobic agents such as hydrocarbons, halogenated hydrocarbons, fluorinated materials to afford additional repellency, and antimicrobial or dust mite inhibiting agents for microbial control may be added.

These unconsolidated fibers, and the fabrics formed from them, are directed towards bedding such as mattresses and futons, but are not limited to bedding. The fabrics may also be used in clothing, linens, or any other fabric application which needs fire resistance with water durability.

The following examples illustrate the practice of this invention. They are not intended to be exhaustive of all possible variations of the invention. Parts and percentages are by weight unless otherwise indicated. All percentages are by weight unless otherwise specified.

### EXAMPLES

### Invention Example 1

First a chemical solution was prepared by mixing 40 grams of Flame proof® 1945 (an aqueous solution of ammonium polyphosphate available from Apex Chemical Corporation of South Carolina), 40 grams of urea (available from Aldrich Chemical of Wisconsin), and 120 grams of deionized (DI) water. Approximately 20 grams of rayon fiber product 40122 (cellulosic fiber, dull, 3.3 denier, 60 mm long, available from Consolidated Fibers of North Carolina) was immersed into the chemical solution. The mixture was tumbled on moving rolls for 15 minutes, and excess liquid was extracted by centrifugation. The fiber was then dried at 50° C. for approximately 10 minutes, and heated at 140° C. for 15 minutes.

### Invention Example 2

Example 2 was produced in the same method as Invention Example 1 except that the fiber was heated at 155° C. for 10 minutes.

### Invention Example 3

Example 3 was produced in the same method as Invention Example 1 except that the fiber was heated at 165° C. for 10 minutes.

### Comparative Example 1

Comparative Example 1 was prepared in the same method as Example 2 except that the chemical solution contained only 40 grams of urea and 160 grams of DI water.

### Comparative Example 2

Comparative Example 2 was prepared in the same method as Example 2 except that the chemical solution contained only 40 grams of Flame proof® 1945 and 160 grams of DI water.

Approximately 10 grams of treated fibers from each of the above examples were dipped into about water for approximately 10 minutes and then the fibers were squeezed to remove excess water. The dip process was repeated 2 more times. The fibers were then air dried followed by drying at 80° C. Approximately 5 grams of each of the fibers were then made into a loose bundle and subjected to a 1 inch (2.54 cm) long flame from a lighter for 10 seconds at the bottom of the fiber bundle. The burning property results are recorded in Table 1. In addition, phosphorus count of each fiber bundle was measured by X-ray fluorescence (labeled P counts Table 1).

TABLE 1
Burn property results

| Samples | P counts | Burning property |
|---|---|---|
| Invention Ex. 1 | 30145 | Self extinguish |
| Invention Ex. 2 | 34928 | Self extinguish |
| Invention Ex. 3 | 37646 | Self extinguish |
| Comparative Ex. 1 | — | Completely burned off |
| Comparative Ex. 2 | 6501 | Completely burned off^{a} |

^{a}fiber turned brown after treatment

As can been seen from Table 1, the inventive examples give good fire retardancy to the fiber bundles and are also water leach resistant. The combination of the chemicals and the drying temperatures creates water resistant and fire resistant fibers. Using only phosphate salt treatment affords fire retardancy, but is not water leach resistant.

### Invention Example 4

First a chemical solution was prepared by mixing 20 grams of Flame proof® 1945 (an aqueous solution of ammonium polyphosphate available from Apex Chemical Corporation of South Carolina), 20 grams of urea (available from Aldrich Chemical of Wisconsin), and 160 grams of deionized (DI) water. Approximately 20 grams of rayon fiber product 40122 (cellulosic fiber, dull, 3.3 denier, 60 mm long, available from Consolidated Fibers of North Carolina) was immersed into the chemical solution. The mixture was tumbled on moving rolls for 15 minutes, and excess liquid was extracted by centrifugation. The fiber was then dried at 50° C. for approximately 10 minutes, and heated at 150° C. for 10 minutes.

### Comparative Example 3

Comparative Example 3 was prepared in the same method as Invention Example 3 except that the chemical solution contained 30 grams of urea phosphate and 170 grams of DI water. There was no Flame proof in the sample.

### Comparative Example 4

Comparative Example 4 was prepared in the same method as Invention Example 4 except that the chemical solution contained 20 grams of Flame proof 1945, 4 grams of Phobotex JVA (a hydrocarbon dispersion from Ciba Specialty Chemical of North Carolina), and 176 grams of DI water. The solution did not contain a weak base.

### Comparative Example 5

Comparative Example 5 was prepared in the same method as Invention Example 4 except that the chemical solution contained 40 grams of Glotard PSD (an aqueous dispersion of ammonium polyphosphate with hydrocarbon from Glo-tex International of Spartanburg, South Carolina) and 160 grams of DI water. In addition, the fibers were heated at 110° C. instead of 150° C. for 10 minutes.

### Comparative Example 6

Comparative was prepared in the same method as Invention Example 4 except that the fiber was heated at 130° C. instead of 140° C. for 10 minutes.

Approximately 10 grams fibers from each of the above examples were dipped in DI (deionized) water for 10 minutes and squeezed to remove excess liquid. The procedure was repeated once. Fibers were then dried at 80° C. Approximately 5 grams of each of the dried samples were made into loose bundle. The bundles were subjected to about 1 inch flame from bottom of the bundle for 10 seconds. The burning property and the phosphorus counts are recorded in Table 2.

TABLE 2
Example burn results

| Samples | P count | Burning property |
|---|---|---|
| Example 4 | 16969 | Self extinguished |
| Comparative 3 | 20695 | Completely burned off |
| Comparative 4 | 13790^{c} | Completely burned off^{b} |
| Comparative 5 | 4613 | Completely burned off |
| Comparative 6 | 3376 | Completely burned off |

^{b}fibers dipped in water once only.

As can been seen from Table 2, urea phosphate treated fibers have poor fire retardancy. Hydrophobically treated ammonium polyphosphate does not offer fibers fire retardancy with water durability either. Only inventive example 4 with ammonium polyphosphate and weak base urea give fibers fire retardancy and water durability.

The invention has been described in detail with particular reference to certain preferred embodiments thereof, but it will be understood that variations and modifications can be effected within the spirit and scope of the invention.

What is claimed is:

1. A process for forming a fire resistant textile comprising:
treating unconsolidated fibers with an aqueous solution comprising a phosphoric or phosphonic acid salt and a weak base;
drying the fiber at 140 to 200° C.; and,
forming the treated fibers into a textile.

2. The process of claim 1, wherein the fiber comprises a hydroxyl group.

3. The process of claim 1, wherein the fiber comprises a cellulosic fiber.

4. The process of claim 3, wherein the cellulosic fiber comprises rayon.

5. The process of claim 1, wherein the textile is not washed.

6. The process of claim 1, wherein the textile is not treated with a conditioner.

7. The process of claim 1, wherein the textile is selected form the group consisting of a knit, woven, or nonwoven textile.

8. The process of claim 1, wherein the ratio by molar ratio of the phosphoric or phosphonic acid salt and the weak base is between 0.1:1 and 2:1.

9. The process of claim 8, wherein the ratio by molar ratio of the phosphoric or phosphonic acid salt and the weak base is between 0.25:1 and 1:1.

10. The process of claim 1, wherein the treated fiber comprises 5 to 25% by weight the phosphoric or phosphonic acid salt.

11. The process of claim 1, wherein the phosphoric acid salt comprises ammonium hydrogenephosphate.

12. The process of claim 1, wherein the phosphoric acid salt comprises ammonium dihydrogenephosphate.

13. The process of claim 1, wherein the phosphoric acid salt comprises ammonium polyphosphate.

14. The process of claim 1, wherein the weak base comprises urea or cyanoguanidine.

15. The process of claim 1, wherein the fiber is dried at 150 to 170° C.

16. A process for forming a fire resistant textile comprising:
treating unconsolidated first fibers with an aqueous solution comprising a phosphoric or phosphonic acid salt and a weak base;
drying the fiber at 140 to 200° C.;
mixing the first treated fibers with second untreated fibers; and,
forming the first treated fibers and second untreated fibers into a textile.

17. The process of claim 16, wherein the second fibers comprise a polymer with a melt temperature of less than 185° C.

18. The process of claim 16, wherein the first treated fibers and the second untreated fibers are mixed such that the second untreated fibers are in a weight percentage of between 10 and 30%.

19. A process for forming a fire resistant textile comprising:
treating unconsolidated cellulosic fibers with an aqueous solution comprising ammonium polyphosphate and urea;
drying the fiber at 150 to 170° C.; and,
forming treated fibers into a non-woven textile.
